(19) United States
(12) Patent Application Publication
(10) Pub. No.: US 2006/0284698 A1
(43) Pub. Date: Dec. 21, 2006

(54) Low-loss microstrip transmission line structure and a method for its implementation

(75) Inventor: Risto Vaisanen, Salo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/154,934

(22) Filed: Jun. 15, 2005

(51) Int. Cl. H01P 5/10

(52) U.S. Cl. 333/26

(57) ABSTRACT

A signal carrying microstrip (510) is an integral part of the passive part (502) or the active part (501) of an RF-IC (integrated circuit carrying radio frequency signals). The ground plane (511) is an integral part of the base plate (503) of an RF-IC. The distance (h) between the microstrip (510) and the ground plane (511) is determined by the geometrical properties of the passive or the active part, of the base plate, and of the elements that act as spacers between the passive or active part and the base plate. The inventive microstrip structure allows the use of microstrips with different widths in an RF-IC without compromising the other important electrical characteristics like impedance level and inductive coupling. This opens the door for constructing a balun integrated into an RF-IC being able to e.g. make an impedance matching between different impedance levels.

### BACKGROUND AND FIELD OF THE INVENTION

The invention concerns the field of microstrip transmission lines in an integrated circuit carrying radio frequency signals. Especially the invention concerns a structure to realize a low-loss microstrip transmission line into an integrated circuit carrying radio frequency signals and a balanced to unbalanced transformer realized with the aid of the microstrip structure. The invention also concerns a power amplifier the balanced to unbalanced transformer of which is based on the microstrip structure.

In this document the following abbreviations are used when describing the prior art and also when describing the present invention:
Balun Balanced to unbalanced transformer,
FR4 Base material for printed circuit boards (FR=Flame Retardant, and Type “4” indicates woven glass reinforced epoxy resin),
IC integrated circuit,
RF radio frequency,
W/h The ratio of the width (W) of a signal carrying microstrip to the distance (h) between the microstrip and a conductor forming the signal ground.

A generally used construction for RF-integrated circuits (RF-IC) having both active electrical elements and low-loss passive electrical elements is such that the active elements have been integrated into a first part of the IC and the passive elements into a second part of the IC. In the continuation of this document the first part and the second part are referred as ‘the active part’ and ‘the passive part’, respectively. The body of the active part may be made, for example, of silicon and the body of the low-loss passive part may be made, for example, of glass. A side view of an exemplary system of this kind is illustrated in FIG. 1. The active part 101 and the passive part 102 are electrically connected to each other via electrically conductive solder bumps 103, 104 and via electrically conductive areas 105 on the base plate 106, i.e. the flip-chip technique. It is also possible to accomplish said electrical connections using some other techniques like e.g. wire bonding. The base plate 106 may be made, for example, of FR4. This whole system may be encased into e.g. a plastic package 109. In this document a system 120 consisted of the parts inside the package 109 plus the package 109 itself is called an RF-IC. The RF-IC is connected with the circuit board 110 (a fraction of that shown in FIG. 1) via the solder bumps 107 and 108.

### DESCRIPTION OF THE PRIOR ART

Into an RF-IC it is possible to implement different strip line designs like symmetrical strip lines for differential signals and also microstrip structures having a signal carrying conductor strip and a ground plane. In this document we concentrate on an asymmetrical structure having a signal carrying microstrip and a ground plane. A perspective view of a prior art construction for an microstrip transmission line is shown is FIG. 2. The direction of the signal propagation is parallel or opposite to the Z-axis. A body 201 has been coated with conductive material that forms the ground plane 202. The ground plane has in turn been coated with layer of dielectric insulator 203. The microstrip 204 carrying a signal has been mounted on the surface of the insulator layer 203. The body 201 may, for example, be the body of the passive part mentioned above.

The impedance is an important property of a microstrip transmission line. The quantities that mainly determine the impedance are the width of the strip, denoted with W in FIG. 2, the thickness of the insulator layer between the strip and the ground plane, denoted with h in FIG. 2, and the electromagnetic properties of the insulator 203, such as the electrical permittivity and the magnetic permeability.

The microstrip structure according to the prior art involves severe drawbacks due to the fact that the thickness of the insulating layer h is limited because of the reasons associated with the manufacturing processes. In certain cases the maximum reachable distance may be as low as 10 μm. In many cases the impedance of the microstrip has a minimum allowable level that has to be reached. The impedance is, in turn, roughly speaking inversely proportional to the width of the microstrip W and directly proportional to the thickness of the insulator layer h. Therefore, the W/h ratio must not exceed a certain limit. Because of the fact that the thickness of the insulator layer h is limited, also the width of the strip W is limited if a certain minimum allowable level of the impedance is required. The impedance can be increased by making the microstrip narrower. The drawback associated with narrowing the microstrip is the fact that the serial resistance grows. This becomes a problem when the power losses in the system should be low and/or the system should be able to handle high power levels.

For a push-pull power amplifier to work properly, a broadband balanced to unbalanced transformer, hereinafter balun, with excellent amplitude and phase balance is needed for transforming the balanced output signal of the amplifier to an unbalanced signal. The balun can be realized with microstrip structures, see e.g. reference Fl103614. When using the microstrip structure according to prior art for integrating a balun into an RF-IC severe drawbacks are, however, introduced. For instance, if the balun has to be able to handle the power outputted by e.g. a power amplifier in the transmitter of a mobile phone the strips have to be wide enough for being able to carry the power with losses small enough but this would lead to a too low impedance level. Furthermore, also due to the limitation on the insulator thickness h it is infeasible to arrange a suitable W/h ratio for reaching a sufficient inductive coupling between the microstrips associated with a signal input side and a signal output side of the balun.

The fact that the width of the microstrip W has to be limited if a certain level of impedance is desired and/or the fact that the inductive coupling between different strips is weak has/have also harmful effects when using the prior art microstrip structure for e.g. directional couplers, impedance transformers, and filters.

A power amplifier using a push-pull type active stage is presented in FIG. 3. In this document a term ‘push-pull’ in conjunction with a power amplifier means that a power amplifier has a two-sided output stage controlled in a way that output signals of the sides are in opposite phases. The RF input signal is coupled to the bases of the output stage transistors 301 and 302 through the dc-decoupling capacitors 311 and 312. Also the base bias currents IB1 and IB2 are fed to the bases of the transistors 301 and 302. The signal output terminals of the transistors (e.g. collectors) are fed by dc-currents IC1 and IC2 for reaching a desired operating point for the transistors. The currents IC1 and IC2 are fed through inductors 321 and 322 by the dc-voltage source 331. The signal outputs of the transistors, nodes 341 and 342 in FIG. 3, are connected via an impedance transformer 351 to the balun 361. The balun 361 has been presented by a schematic circuit diagram that does not have any relation with different balun constructions. The RF-output signal is taken from the output port of the balun. The drawbacks of the circuit shown in FIG. 3 are the following:
An impedance transformer is needed. This is due to the fact that the output impedance of the amplifier, i.e. the impedance seen between the nodes 341 and 342 towards transistors, is low, in the order of few ohms. The input impedance of the balun, i.e. the impedance seen between the nodes 343 and 344 towards the balun, is significantly higher. The impedance transformer means costs, a need for space, and power losses.
Inductors carrying the dc-currents for adjusting the transistor operating points are needed. The inductors mean costs, a need for space, and power losses. Many times the inductors have to be realized as discrete components meaning also an increase in the number of components to be assembled in a production line.

A prior art solution for avoiding the need for the inductors 321 and 322 is to feed the currents IC1 and IC2 through the balun 361. This is accomplished by coupling the dc-voltage source 331 with the node 345 in balun 361. This in turn induces the following problems:
The balun has to be able to carry the dc-currents IC1 and IC2 so that the power loss is not too high. This requirement makes the realization of a balun that is integrated in an RF-IC using the prior art mictrostrip structure even more infeasible.
The impedance transformer 351 should be such that dc-currents are able to flow through it. Due to the fact that there is a reasonable mismatch between the output impedance of the amplifier and the input impedance of the balun the capacitive impedance transformer has to be realized such that the impedance matching is based at least partially on serial resonance. The drawback is the fact that this kind of a serial resonance system is not able to transfer a dc-current because of serial capacitors. Another approach would be to lower the impedance level of the balun by broadening and shortening the balun strips. This would also weaken the inductive coupling between the balun strips and, therefore, the attenuation of the balun would become unacceptably high.

### BRIEF DESCRIPTION OF THE INVENTION

It is an objective of the present invention to provide a low-loss microstrip transmission line structure for an RF-IC, which microstrip structure avoids the boundary condition associated with the width of the microstrip when targeting a certain level of impedance and/or a certain level of inductive coupling between different strips and which microstrip structure allows the integration of a balun into an RF-IC. It is also an objective of the present invention to remove or mitigate the drawbacks associated with a push-pull power amplifier when using a balun according to the prior art. Furthermore, it is an objective of the present invention to provide a method for implementing a low-loss microstrip transmission line structure into an RF-IC. It is also an objective of the present invention to provide a mobile phone in which the drawbacks associated with a microstrip structure according to the prior art have been removed or mitigated.

The objectives of the invention are achieved with a microstrip construction where the conductive material that forms the ground plane is mounted on the base plate and the signal carrying conductor strip is mounted on the passive or active part. The distance between the signal carrying strip and the ground plane is determined by the geometry of the base plate, by the geometry of the active or passive part and by the geometry of the possible elements between the base plate and the active or passive part. For example, the signal carrying conductor strip can be mounted on the bottom surface of the passive part, the ground plane can be mounted on the top surface of the base plate and the solder bumps may act as spacers between the base plate and the passive part determining the distance between the strip and the ground plane. The invention presents a solution in which the distance between the microstrip and the ground plane may be done substantially longer than the corresponding distance in microsrip structures constructed by the prior art solution into an RF-IC.

The invention yields appreciable benefits compared to prior art solutions:
The solution of the invention allows integration of microstrip structures in an RF-IC so that the integrated microstrip is able to handle power with a small power loss without compromising the other important electrical characteristics like the impedance level and the inductive coupling between different microstrips.
Due to the fact that the distance between the signal carrying strip and the ground plane can be made sufficiently long, the invented microstrip structure allows integration of a balun into an RF-IC so that the balun is able to handle power with a sufficiently small power loss and still has an impedance level of strips high enough and an inductive coupling between different strips strong enough. This means savings in space, number of components, electrical losses, and costs. E.g. the power of the output stage of a transmitter in a mobile phone can be handled by a balun integrated into an RF-IC.
The invented microstrip structure allows the use of microstrips with different widths in an RF-IC without compromising the other important electrical characteristics like impedance level and inductive coupling. This opens the door for constructing a balun integrated into an RF-IC being able to make an impedance matching between different impedance levels, e.g. between impedance levels of few ohms and 50 ohms.
The invented microstrip structure allows constructing a push-pull power amplifier having a balun element integrated into an RF-IC.
The invented microstrip structure offers a significant step forward when designing a push-pull power amplifier in which the dc-currents for adjusting the operating points of the output stage transistors flow through the balun integrated into an RF-IC and in which the need for separate inductors may thus be avoided.
The invented microstrip structure allows the arranging of sufficient distance between the signal carrying strip and the ground plane without any extra manufacturing phases and costs when solder bumps make the spacing.
The invented microstrip structure allows underfill material between the signal carrying strip and the ground plane to be e.g. air, so the dielectrical losses in the underfill are low. It is, however, possible to use other underfill material if the manufacturing process requires it.
The invented microstrip structure allows integration of other electrical elements like directional couplers, impedance transformers, and filters in an RF-IC such that their electrical characteristics can be designed more freely than when using the prior art microstrip structure.

A microstrip structure according to the invention, comprising
an electrically conductive microstrip, and
an electrically conductive ground plane;
   the microstrip structure being integrated into an integrated circuit comprising a base plate and at least one electrical part that is either an active part for active electrical elements or a passive part for passive electrical elements, is characterized in that
the electrically conductive microstrip is an integral part of the electrical part, and

the electrically conductive ground plane is an integral part of the base plate.

A balanced to unbalanced transformer, hereinafter balun, according to the invention, comprising
an electrical conductor forming a signal input side of the balun, and
an electrical conductor forming a signal output side of the balun, and
an electrically conductive ground plane common for both the signal input side and the signal output side;
   the balun being integrated into an integrated circuit comprising a base plate and a passive part for passive electrical elements, is characterized in that
the electrical conductor forming the signal input side is an electrically conductive microstrip that is an integral part of the passive part, and
the electrical conductor forming the signal output side is an electrically conductive microstrip that is an integral part of the passive part, and
the electrically conductive ground plane is an integral part of the base plate.

A power amplifier according to the invention having components in an active part of an RF-IC, in a passive part of an RF-IC, and in a base plate of an RF-IC, comprising
a push-pull type active stage located in the active part of an RF-IC, and
conductors between the active part and the passive part of an RF-IC, and
a balun comprising an electrical conductor forming a signal input side of the balun, an electrical conductor forming a signal output side of the balun, and an electrically conductive ground plane of the balun common for both the signal input side and the signal output side;
   is characterized in that
the electrical conductor forming the signal input side of the balun is an electrically conductive microstrip that is an integral part of the passive part, and
the electrical conductor forming the signal output side of the balun is an electrically conductive microstrip that is an integral part of the passive part, and
the electrically conductive ground plane of the balun is an integral part of the base plate.

A method for implementing a microstrip structure according to the invention into an integrated circuit comprising a base plate and at least one electrical part that is either an active part for active electrical elements or a passive part for passive electrical elements is characterized in that the method comprises
mounting an electrically conductive microstrip into the electrical part, and
mounting an electrically conductive ground plane into the base plate, and
assembling the electrical part and the base plate together in a way that an imaginary line that is normal to the electrically conductive microstrip is substantially normal to the electrically conductive ground plane, and the electrically conductive microstrip and the electrically conductive ground plane are at least partially overlapping when seen along the direction of the imaginary normal line.

A mobile phone according to the invention, comprising a microstrip structure having
an electrically conductive microstrip, and
an electrically conductive ground plane,
   and being integrated into an integrated circuit comprising a base plate and at least one electrical part that is either an active part for active electrical elements or a passive part for passive electrical elements, is characterized in that
the electrically conductive microstrip is an integral part of the electrical part, and
the electrically conductive ground plane is an integral part of the base plate.

Features of various advantageous embodiments of the invention are described further below.

The exemplary embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF FIGURES

The invention and its other advantages are explained in greater detail below with reference to the accompanying drawings, in which

FIG. 1 is a schematic side view of a construction of an integrated RF-circuit, according to the prior art,

FIG. 2 is a schematic perspective view of a microstrip transmission line structure according to the prior art, the direction of the signal propagation is parallel or opposite to the Z-axis,

FIG. 3 is a circuit diagram of a power amplifier using a push-pull type active stage, according to the prior art,

FIGS. 4a, 4b and 4c present side view cross-sections of exemplary embodiments of the invention,

FIG. 5 presents an advantageous embodiment of the microstrip structure according to the invention as a side view cross-section,

FIGS. 6a, 6b, 6c and 6d present an exemplary arrangement of the microstrip conductors for the circuits carrying balanced and unbalanced signals and the ground plane for them in a balanced to unbalanced transformer realized with a microstrip structure according to the invention,

FIG. 7 is a circuit diagram of a power amplifier using a push-pull type active stage in which separate inductors for the dc-currents to be fed to the signal output terminals of the transistors and a separate impedance transformer unit has been avoided using a balun integrated on a passive part of an RF-IC.

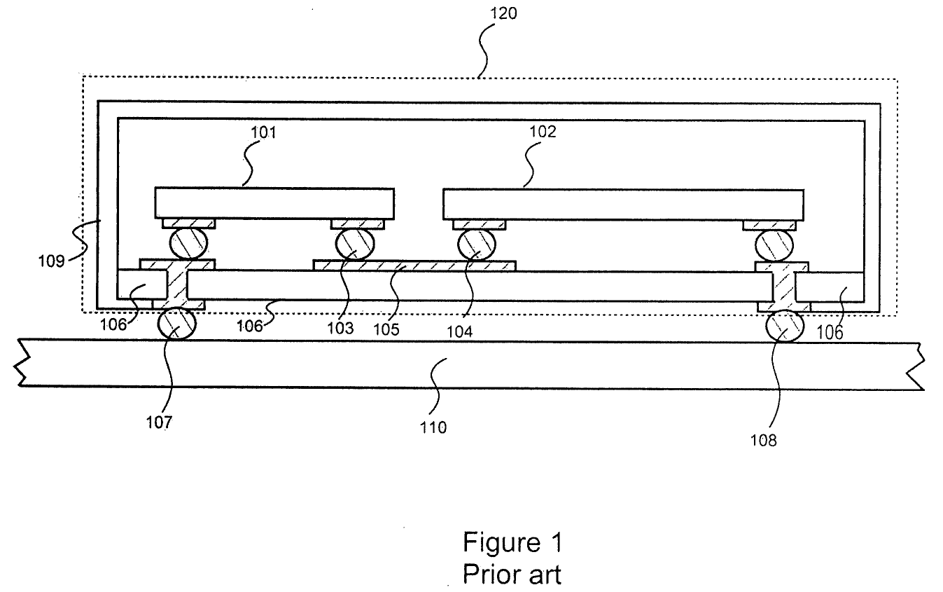

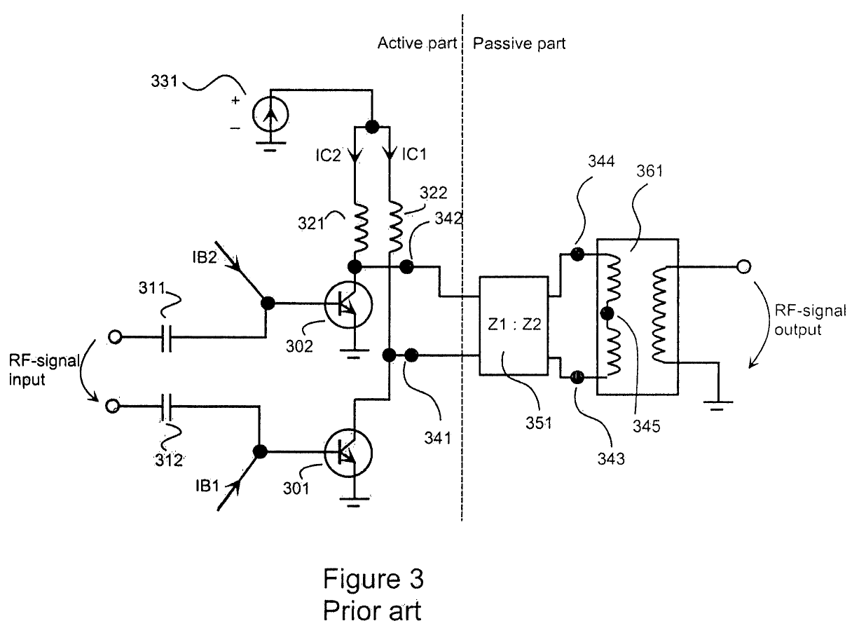

FIGS. 1-3 have been explained above in the description of the prior art.

### DESCRIPTION OF THE PREFERRED EMBODIMENTS

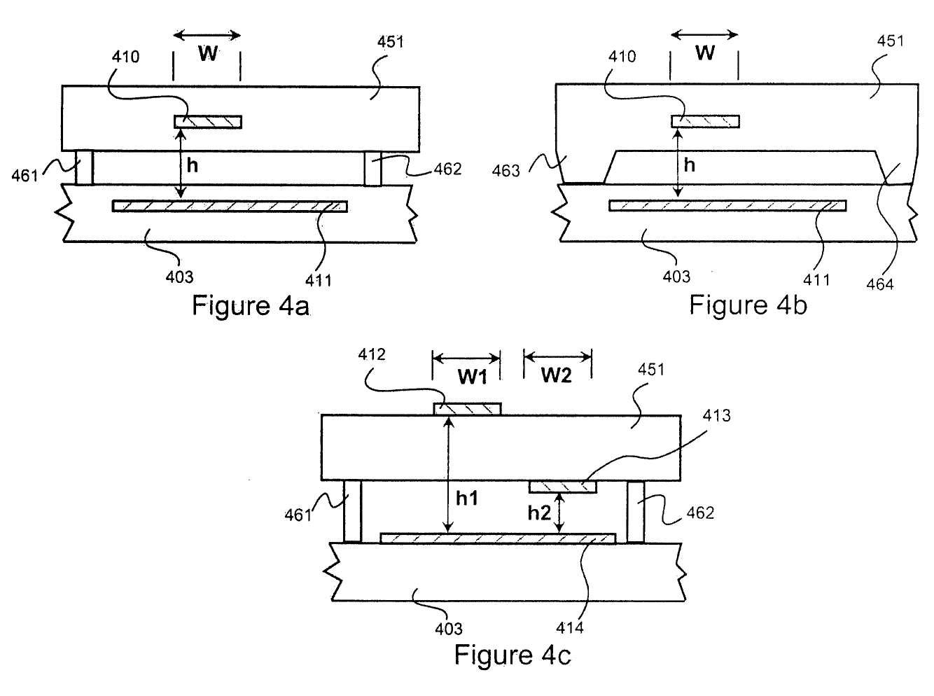

A microstrip and a ground plane are co-operative parts of a transmission line system along which a signal propagates in a form of electromagnetic fields between the microstrip and the ground plane. One or more microstrips may use a same ground plane in common. In a microstrip structure according to the invention a microstrip is an integral part of the passive or active part of an RF-IC, and a ground plane is an integral part of the base plate of an RF-IC. FIGS. 4a, 4b and 4c present side view cross-sections of exemplary embodiments of the invention. The part 451 in FIGS. 4a, 4b and 4c may be either the passive part of an RF-IC or the active part of an RF-IC, and hereinafter the part 451 is referred as ‘the electrical part’. The direction of the signal propagation is normal to the figure plane.

In FIG. 4a a microstrip 410 is an integral part of the electrical part 451 in a way that the microstrip 410 is inside the electrical part 451. A ground plane 411 is an integral part of the base plate 403 of an RF-IC in a way that the ground plane 411 is inside the base plate 403 (only a fraction of the base plate is shown). The distance h between the microstrip 410 and the ground plane 411 is determined by the geometrical properties of the electrical part 451, of the base plate 403, and of the elements 461 and 462 that act as spacers between the electrical part 451 and the base plate 403. The spacers may be solder bumps between the electrical part 451 and the base plate 403 being at the same time used as signal paths, or the spacers may be dedicated elements used only for making a distance between the electrical part and the base plate. Especially such spacers that are not used as signal paths may be made of various different materials.

FIG. 4b presents an embodiment of the invention where spacers are elevations 463, 464 made on a surface of the electrical part 451 or the base plate 403. An elevation made on a surface of the electrical part or the base plate may also be an elevated area on said surface. In some embodiments of the invention the spacers are not needed. In the embodiment of the invention shown in FIG. 4a a distance between the microstrip 410 and the ground plane 411 can be arranged also without the spacers 461 and 462 by adjusting the location of the microstrip inside the electrical part and/or by adjusting the location of the ground plane inside the base plate.

FIG. 4c presents an embodiment of the invention in which there are two microtrips that are using a common ground plane. Microstrips 412 and 413 are integral parts of an electrical part 451 in a way that the microstrip 412 is located on a surface of the electrical part 451 that faces away from the base plate 403 and the microstrip 413 is located on a surface of the electrical part 451 that faces towards the base plate 403. A ground plane 414 is an integral part of the base plate 403 in a way that the ground plane 414 is located on a surface of the base plate 403 that faces towards the electrical part 451.

A mobile phone according to this embodiment of the invention is such that the mobile phone comprises an RF-IC in which a microstrip structure described above and in FIG. 4 is used for realizing a directional coupler and/or an impedance transformer and/or a filter and/or a balun.

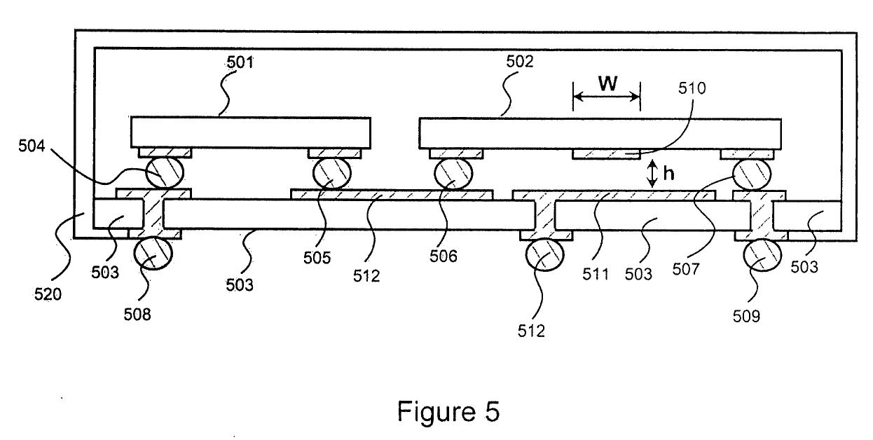

FIG. 5 presents an advantageous embodiment of the invention in which the distance h between the microstrip 510 and the ground plane 511 is determined by the solder bumps 506 and 507. The microstrip is mounted on the surface of the passive part 502 that faces towards the base plate 503. The ground plane 511 is mounted on the surface of the base plate 503 that faces towards the active and the passive parts 501 and 502. The ground plane 511 may be connected e.g. to the ground of a circuit board via the solder bump 512. It is also possible to arrange a microstrip structure according to the invention into the active part 501. Furthermore, a microstrip structure according to the invention on certain areas on the active part 501 and/or on the passive part 502 does not prevent the usage of a ground plane and/or prior art microstrip structures attached to other areas on the active and/or on the passive part. The material in the space between the microstrip 510 and the ground plane 511 may be e.g. air, so the dielectrical losses in that material can be minimized. It is, however, possible to use other underfill material if the manufacturing process requires it.

A mobile phone according to this embodiment of the invention is such that the mobile phone comprises an RF-IC in which a microstrip structure described above and in FIG. 5 is used for realizing a directional coupler and/or an impedance transformer and/or a filter and/or a balun.

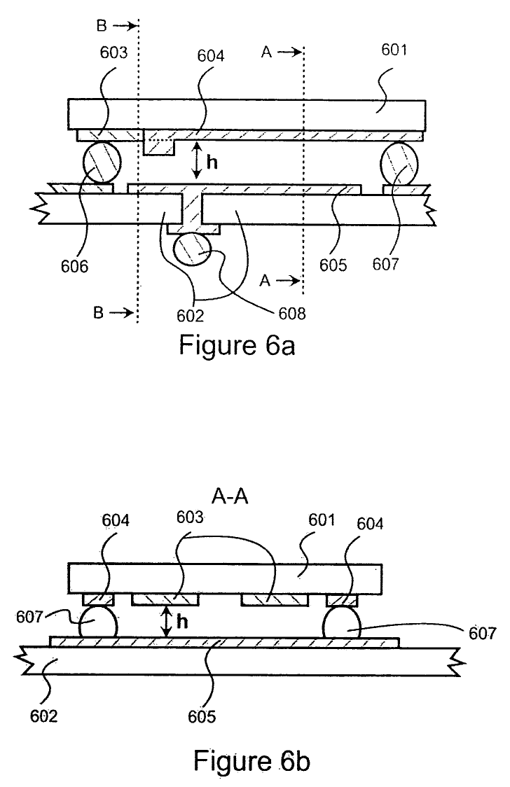

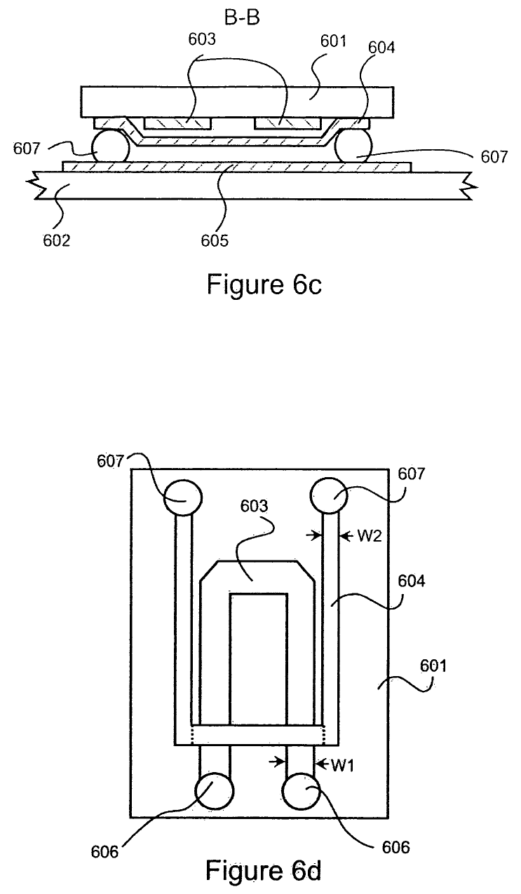

FIGS. 6a, 6b, 6c and 6d present an exemplary balun construction realized with the aid of the microstrip structure according to the invention. FIG. 6a presents a side view of a passive part 601 and a piece of a base plate 602 to which microstrips 603 and 604 and a ground plane 605 according the invention have been arranged to form a balun. The cross section A-A marked in FIG. 6a is presented in FIG. 6b and the cross-section B-B marked in FIG. 6a is presented in FIG. 6c. A bottom view of the passive part 601 with microstrips 603 and 604 is shown in FIG. 6d. As seen from FIG. 6c it is possible that there are microstrips in more than one layer. Because of the fact that the distance from the microstrips 603 and 604 to the ground plane 605 is significantly longer than that of the prior art solution the widths of the microstrips 603 and 604, W1 and W2, may be selected so that the desired electrical properties are achieved. The ground plane 605 may be connected via solder bump 608 to the ground of the circuit board the RF-IC is mounted on, and utilizing this, an electrical connection between the ground plane 605 and the active part and/or the passive part may be arranged.

An embodiment of a balun realized with a microstrip structure according to the invention is such that the widths of the microstrips, W1 and W2, of the signal input side and the signal output side are chosen in a way that desired impedance levels are obtained for said signal input side and signal output side and, therefore, the balun is able to act as an impedance transformer. By using appropriate capacitive elements at the signal input side and/or at the signal output side the system can be used as a band pass filter in which the balun provides the inductive element needed. Another embodiment of a microstrip balun according to the invention is such that the microstrip of the signal input side that is connected to the output of a push-pull type active stage is chosen to be so wide that the dc-currents to be fed to the signal output terminals (e.g. collectors) of the output stage transistors may be fed through the balun microstrips. Therefore, the need for separate inductors may be avoided.

A mobile phone according to this embodiment of the invention is such that the mobile phone comprises an RF-IC comprising a balun described above and in FIG. 6.

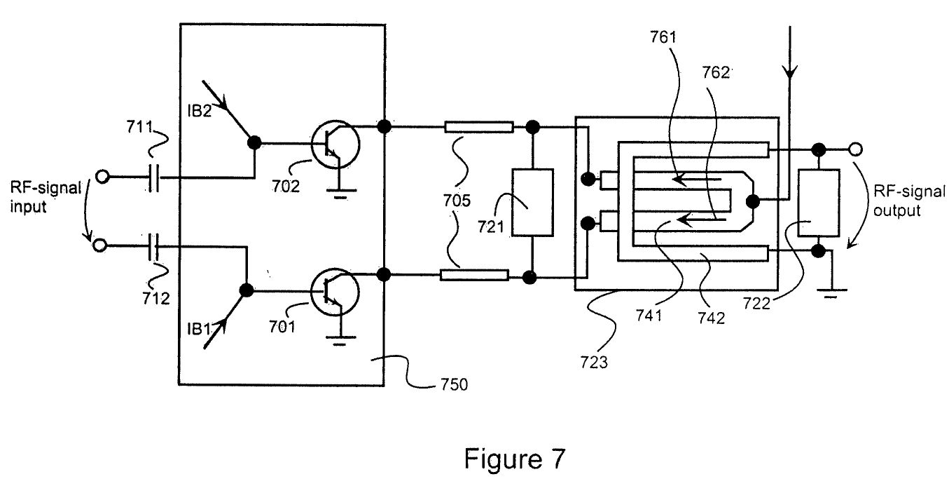

FIG. 7 presents a circuit diagram of a power amplifier using a push-pull type active stage 750. The push-pull active stage is located in the active part of the RF-IC. A need for separate inductors for dc-currents to be fed to signal output terminals (e.g. collectors) of output stage transistors 701 and 702 has been avoided by using a signal input side 741 of the balun for the functionality of the separate inductors. The balun 723 is located in the passive part of the RF-IC. The active part has been connected to the passive part via conductors 705. The dc-currents 761 and 762 for the output stage transistors 701 and 702 are fed via the signal input side 741 of the balun and via the conductors 705. The method for generating the dc-currents is immaterial from the view point of this invention. As mentioned earlier in this document the invented microstrip structure allows the width of the microstrip 741 to be selected such that the dc-currents may be conducted with a small enough power loss. The prerequisite for using the balun for the dc-currents 761 and 762 is the fact that impedance transformation between the balun 723 and the output of the push-pull stage 750 does not require a use of serial capacitors.

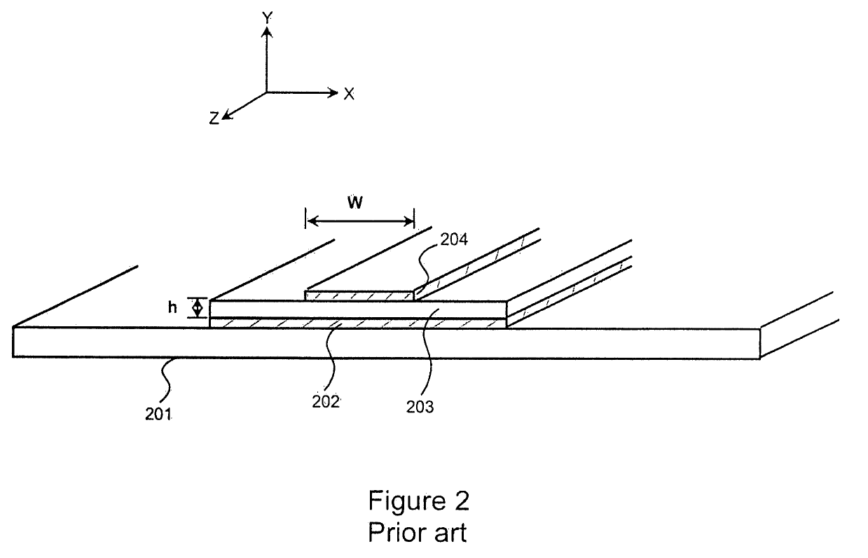

In an advantageous embodiment of the invention the problem associated with the impedance transformation is solved by utilizing the electrical properties of the conductors 705 between the active part of an RF-IC and the passive part of the RF-IC. The conductors 705 may be realized e.g. with the flip-chip technique as shown in FIG. 1 or with the wire-bonding technique or with some other technique. In this description the means, e.g. solder bumps, for coupling the electrically conductive wires or strips with the active part and with the passive part are seen as integral parts of the conductors 705. The problem associated with the impedance matching is solved by designing the conductors 705 in a way that the impedance level seen from the balun 723 towards the active part has such a value that the impedance matching can be accomplished by a capacitive parallel connected element 721 and a need for serial capacitors is avoided. The impedance level seen from the balun towards the push-pull stage is adjusted by a proper choice of manufacturing materials and geometrical properties of the conductors 705 and/or of the electrically and/or magnetically conductive elements within the proximity of the conductors; e.g. the length of the conductors, the mutual distance between them, the width of a conductive strip if the flip-chip technique is used. The geometrical properties producing the desired impedance level may be obtained e.g. with prototype experiments and measurements. The system consisting of the conductors 705 and the capacitive parallel element 721 acts also as a balanced low pass filter that is usually needed at the output of a push-pull type active stage 750. Also a capacitive parallel element 722 and the balun 723 produce a filter effect. The impedance matching on both the signal input and the signal output sides of the balun is at least partly accomplished with a proper choice of the widths of the microstrips of the balun 723. As mentioned earlier in this document the invented microstrip structure allows the width of a microstrip to be selected more freely than when using a microstrip structure according to the prior art, FIG. 2.

A mobile phone according to this embodiment of the invention is such that the mobile phone comprises an RF-IC comprising a push-pull type power amplifier described above and in FIG. 7.

A method for implementing a microstrip structure according to the invention into an RF-IC comprises
mounting an electrically conductive microstrip into a passive or active part of an RF-IC depending on which part the microstrip structure is being implemented to, and
mounting an electrically conductive ground plane into a base plate of an RF-IC, and
assembling the passive or active part together with the base plate in a way that an imaginary line that is normal to the electrically conductive microstrip is substantially normal to the electrically conductive ground plane, and the electrically conductive microstrip and the electrically conductive ground plane are at least partially overlapping when seen along the direction of the imaginary normal line.

In this kind of case when a distance between the electrically conductive mictrostrip and the electrically conductive ground plane is determined by the mechanics of the microtrip structure an impedance and/or a dc-resistance of the electrically conductive microstrip can be further affected by selecting the width of the microstrip. Another factor that can be used for determining the impedance and/or the dc-resistance of the electrically conductive microstrip is naturally the thickness of the microstrip. In this document we assume that the thickness has been selected optimally for a purpose in hand within the limits dictated by a manufacturing process and the final value of the impedance and/or the dc-resistance is/are determined by the width of the microstrip.

The assembling of the passive or active part together with the base plate may be accomplished with the aid of solder bumps so that the solder bumps determine the distance between the passive or active part and the base plate. In a case that the active and the passive part are electrically connected to each other and/or to the base plate by using e.g. the wire bonding technique and a certain spacing is still desired between the passive or active part and the base plate it is possible to use dedicated spacer elements between the passive or active part and the base plate. Naturally the spacers may be made of solder.

We claim:

1. A microstrip structure, comprising
an electrically conductive microstrip, and
an electrically conductive ground plane;
the microstrip structure being integrated into an integrated circuit comprising a base plate and at least one electrical part that is either an active part for active electrical elements or a passive part for passive electrical elements, wherein
the electrically conductive microstrip is an integral part of the electrical part, and
the electrically conductive ground plane is an integral part of the base plate.

2. A microstrip structure according to claim 1, wherein the electrically conductive microstrip is located on a surface of the electrical part that faces towards the base plate, and the electrically conductive ground plane is located on a surface of the base plate that faces towards the electrical part.

3. A microstrip structure according to claim 1, wherein the electrical part is the passive part of an RF-IC.

4. A microstrip structure according to claim 1, wherein the electrical part is the active part of an RF-IC.

5. A microstrip structure according to claim 1, wherein the microstrip structure comprises solder bumps between the electrical part and the base plate so that the solder bumps are disposed to determine the distance between the electrical part and the base plate.

6. A microstrip structure according to claim 1, wherein the microstrip structure comprises one or more spacer elements for determining the distance between the electrical part and the base plate.

7. A microstrip structure according to claim 1, wherein a surface of the electrical part comprises one or more elevated areas for determining the distance between the electrically conductive microstrip and the electrically conductive ground plane.

8. A microstrip structure according to claim 1, wherein a surface of the base plate comprises one or more elevated areas for determining the distance between the electrically conductive microstrip and the electrically conductive ground plane.

9. A microstrip structure according to claim 1, wherein the material in the space between the microstrip and the ground plane is air.

10. A balanced to unbalanced transformer, hereinafter balun, comprising
an electrical conductor forming a signal input side of the balun, and
an electrical conductor forming a signal output side of the balun, and
an electrically conductive ground plane common for both the signal input side and the signal output side;
the balun being integrated into an integrated circuit comprising a base plate and a passive part for passive electrical elements, wherein
the electrical conductor forming the signal input side is an electrically conductive microstrip that is an integral part of the passive part, and
the electrical conductor forming the signal output side is an electrically conductive microstrip that is an integral part of the passive part, and
the electrically conductive ground plane is an integral part of the base plate.

11. A balun according to claim 10, wherein the ground plane is electrically connected with the ground of a circuit board.

12. A balun according to claim 10, wherein the electrically conductive microstrip forming the signal input side and the electrically conductive microstrip forming the signal output side are located on a surface of the passive part that faces towards the base plate, and the electrically conductive ground plane is located on a surface of the base plate that faces towards the passive part.

13. A balun according to claim 10, wherein the distance between the passive part and the base plate is determined by solder bumps between the passive part and the base plate.

14. A balun according to claim 10, wherein the balun comprises one or more spacer elements for determining the distance between the passive part and the base plate.

15. A balun according to claim 10, wherein a surface of the passive part comprises one or more elevated areas for determining the distance between the electrically conductive microstrips and the electrically conductive ground plane.

16. A balun according to claim 10, wherein a surface of the base plate comprises one or more elevated areas for determining the distance between the electrically conductive microstrips and the electrically conductive ground plane.

17. A balun according to claim 10, wherein the balun is disposed to form a band pass filter in co-operation with capacitive circuit elements connected to at least one of the signal input side and the signal output side of the balun.

18. A power amplifier having components in an active part of an RF-IC, in a passive part of an RF-IC, and in a base plate of an RF-IC, comprising
a push-pull type active stage located in the active part of an RF-IC, and
conductors between the active part and the passive part of an RF-IC, and
a balun comprising an electrical conductor forming a signal input side of the balun, an electrical conductor forming a signal output side of the balun, and an electrically conductive ground plane of the balun common for both the signal input side and the signal output side;
wherein
the electrical conductor forming the signal input side of the balun is an electrically conductive microstrip that is an integral part of the passive part, and
the electrical conductor forming the signal output side of the balun is an electrically conductive microstrip that is an integral part of the passive part, and
the electrically conductive ground plane of the balun is an integral part of the base plate.

19. A power amplifier according to claim 18, wherein the electrically conductive microstrip forming the signal input side of the balun and the conductors between the active part and the passive part of an RF-IC are disposed to conduct dc-currents from a current generating source to signal output terminals of output stage transistors of the push-pull type active stage.

20. A power amplifier according to claim 18, wherein the electrically conductive ground plane of the balun is electrically connected with a ground of a circuit board.

21. A power amplifier according to claim 18, wherein the electrically conductive microstrip forming the signal input side of the balun and the electrically conductive microstrip forming the signal output side of the balun are located on a surface of the passive part that faces towards the base plate, and the electrically conductive ground plane of the balun is located on a surface of the base plate that faces towards the passive part.

22. A power amplifier according to claim 18, wherein the power amplifier comprises a capacitive parallel element, and the conductors between the passive part and the active part of an RF-IC are disposed to perform impedance transformation between the output of the push-pull type active stage and the signal input side of the balun in co-operation with said capacitive parallel element.

23. A power amplifier according to claim 18, wherein the conductors between the passive and the active parts of an RF-IC are realized with the flip-chip technique.

24. A power amplifier according to claim 18, wherein the conductors between the passive and the active parts of an RF-IC are realized with the wire-bonding technique.

25. A power amplifier according to claim 18, wherein the distance between the passive part and the base plate is determined by solder bumps between the passive part and the base plate.

26. A power amplifier according to claim 18, wherein the power amplifier comprises one or more spacer elements for determining the distance between the passive part and the base plate.

27. A power amplifier according to claim 18, wherein the power amplifier comprises a capacitive parallel element, and the conductors between the passive part and the active part of an RF-IC are disposed to form a low-pass filter in co-operation with the capacitive parallel element.

28. A method for implementing a microstrip structure into an integrated circuit comprising a base plate and at least one electrical part that is either an active part for active electrical elements or a passive part for passive electrical elements, wherein the method comprises
mounting an electrically conductive microstrip into the electrical part, and
mounting an electrically conductive ground plane into the base plate, and
assembling the electrical part and the base plate together in a way that an imaginary line that is normal to the electrically conductive microstrip is substantially normal to the electrically conductive ground plane, and the electrically conductive microstrip and the electrically conductive ground plane are at least partially overlapping when seen along the direction of the imaginary normal line.

29. A Method according to claim 28, wherein an impedance of the electrically conductive microstrip is determined by selecting the width (W) of the electrically conductive microstrip.

30. A Method according to claim 28, wherein a dc-resistance of the electrically conductive microstrip is determined by selecting the width (W) of the electrically conductive microstrip.

31. A mobile phone, comprising a mictrostrip structure having
an electrically conductive microstrip, and
an electrically conductive ground plane,
and being integrated into an integrated circuit comprising a base plate and at least one electrical part that is either an active part for active electrical elements or a passive part for passive electrical elements, wherein
the electrically conductive microstrip is an integral part of the electrical part, and
the electrically conductive ground plane is an integral part of the base plate.

32. A mobile phone according to claim 31, wherein the electrically conductive microstrip is located on a surface of the electrical part that faces towards the base plate, and the electrically conductive ground plane is located on a surface of the base plate that faces towards the electrical part.

33. A mobile phone according to claim 31, wherein the electrical part is the passive part of an RF-IC.

34. A mobile phone according to claim 31, wherein the electrical part is the active part of an RF-IC.

35. A mobile phone according to claim 31, wherein the microstrip structure comprises solder bumps between the electrical part and the base plate so that the solder bumps are disposed to determine the distance between the electrical part and the base plate.

36. A mobile phone according to claim 31, wherein the microstrip structure comprises one or more spacer elements for determining the distance between the electrical part and the base plate.

37. A mobile phone according to claim 31, wherein a surface of the electrical part comprises one or more elevated areas for determining the distance between the electrically conductive microstrip and the electrically conductive ground plane.

38. A mobile phone according to claim 31, wherein a surface of the base plate comprises one or more elevated areas for determining the distance between the electrically conductive microstrip and the electrically conductive ground plane.

39. A mobile phone according to claim 31, wherein the material in the space between the microstrip and the ground plane is air.
